(19) United States
(12) Patent Application Publication
(10) Pub. No.: US 2010/0327562 A1
(43) Pub. Date: Dec. 30, 2010

(54) SHOPPING CAR

(76) Inventors: Shigeko Kasuya, Tokyo (JP); Hideki Yumoto, Tokyo (JP)

Correspondence Address: KANESAKA BERNER AND PARTNERS LLP, 1700 DIAGONAL RD, SUITE 310, ALEXANDRIA, VA, 22314-2848, US

(21) Appl. No.: 12/734,361

(22) PCT Filed: Nov. 5, 2008
(86) PCT No.: PCT/JP2008/070118

§ 371 Date: Sep. 2, 2010

(30) Foreign Application Priority Data
Nov. 9, 2007 (JP) 2007-292205

(51) Int. Cl. B62B 1/04; B62B 1/02

(52) U.S. Cl. 280/651; 280/47.131

(57) ABSTRACT

A shopping car which can prevent a person walking on a dark road in the night while pulling the shopping car from stumbling by lighting up the step, or can hold an electronic calculator, a folding umbrella, a portable telephone, and the like, surely as required. LED lights (40) connected sequentially by a feeding cord (41) is arranged on the outer surface on the backside of a bag (30) attached removably to the frame (10), a pocket (45) for an electronic calculator is provided on the inside of a lid (32) covering the upper opening, a pocket (46) for a folding umbrella and a pocket (47) for a portable telephone are provided on the left and right side of the bag (30), and an electronic calculator, a folding umbrella, and a portable telephone are held in these pockets (45, 46, 47).

### FIELD OF THE INVENTION

This invention relates to a shopping car, and more specifically, concerns with a shopping car including a frame having wheels and provided with a bag in which goods are received.

### BACKGROUND OF THE INVENTION

As discloses in Japanese Utility Model Publication S52-24655 and Japanese Utility Model Publication S56-150657, is used a shopping car including a frame with wheels at the lower side, provided with a bag on the receiving member of the frame, a handle being provided for drawing and moving. These shopping cars are widely used as a transfer means of shopping goods. According to these kinds of shopping car, purchased goods can be hold in the bag of the shopping bag of the shopping car, and it will be not necessary to support the weight of the purchased goods. Hence the purchaser is free from the burden to transfer the goods weight.

But the conventional shopping car can not light on near the feet, because the light means are not provided. Thus the conventional shopping car can not serve to prevent the stumbling of the drawer. Further the conventional shopping car is not provided with spaces for receiving a folded umbrella and a mobile telephone. When the umbrella and the telephone are received in the bag, it may be not possible to quickly take them out from the bag because the umbrella and the telephone are mixed among the purchased goods. Further, as the conventional shopping car is not provided with a calculating means, it may be impossible to calculate the total amount of money on shopping.

Prior patent reference 1: Japanese Utility Model Publication S52-24655

Prior Patent reference 2: Japanese Utility Model Publication S56-150657

### DISCLOSURE OF THE INVENTION

### Subject of the Invention

A subject of this invention is to solve the above problems brought by the conventional shopping car.

Another subject of this invention is to provide a shopping car which light on near the feet and prevent the stumbling of the drawer, when walking dark road at night.

Further subject of this invention is to provide a shopping car having exclusive receiving spaces for receiving folded umbrella and mobile telephone.

Further subject of this invention is to provided a shopping car which is provided with an electric calculator received in the predetermined position and the total amount of money can quickly be calculated on purchase.

Further subject of this invention is to provide a shopping car which is folded for carrying or keeping in the rocker when necessary.

Further subject of this invention is to provide a shopping car which directly receiving purchased goods therein when the goods are purchased at the super-market, result in the reduction of polymer bags and indirect distribution of environment problem.

Above subject and other subject will become apparent from the technical spirit of this invention and from the embodiment of this invention.

### Means to Solve the Subject

A main invention of this application relates to
a shopping car, comprising;
a frame having a handle on the upper side and a receiving member on the lower side,
wheels rotatably mounted on the lower side of said frame by means of bearings,
a bag furnished on said frame by supporting the bottom through said receiving member,
a support member provided on said frame receivably and drawerably, and
a rid member furnished on the opening of said bag to open and shut said opening, the rid member having a pocket for receiving an electric calculator which is supported by said support member when said support member is drawn and said rid member opens said opening of said bag for the usage of said electric calculator.

Herein, light means may be provided on the behind-side of said bag. Further, said light means may comprise plural light emission diodes(LED) connected to an electric supply code in order, and the electric supply code is furnished on the behind-side surface of said bag. Still further, a pocket may be furnished on one side of said bag for receiving a folded umbrella. Still further another pocket may be furnished on the another side of said bag for receiving a mobile telephone. Still further, said receiving member may be foldaway relative to said frame, said handle is receivable and drawerable from said frame, and said frame is foldaway.

### Effect of the Invention

The main invention of this application relates to a shopping car, comprising;
a frame having a handle on the upper side and a receiving member on the lower side,
wheels rotatably mounted on the lower side of said frame by means of bearings,
a bag furnished on said frame by supporting the bottom trough said receiving member,
a support member provided on said frame receivably and drawerably, and
a rid member furnished on the opening of said bag to open and shut said opening, the rid member having a pocket for receiving an electric calculator which is supported by said support member when said support member is drawn and said rid member opens said opening of said bag for the usage of said electric calculator.

According to the arrangement of this shopping car, purchaser can input numerals through the keys of the electric calculator which is stably supported on the drawn support member which is receivably and drawerably mounted on the frame, and hence the operationability of the electric calculator is improved.

### BRIEF DESCRIPTION OF THE DRAWINGS

FIG. 1 is a perspective view of a shopping car of this invention.

FIG. 2 is an installed front view and behind view of the shopping car.

FIG. 3 is a side view and folded side view of the shopping car.

FIG. 4 is a perspective view of a shopping car which is folded for carrying.

FIG. 5 is a perspective view of a bag taken-off from the frame.

FIG. 6 is a behind-side front view showing the structure to furnish a support member.

FIG. 7 is a perspective view of the support member which is maintained in a horizontal posture.

FIG. 8 is an essential cross-sectional view of a mechanism which hold the support member horizontally.

### DESCRIPTION OF THE REFERENCE NUMERALS

10 frame

11 pipe

12 bar

13 sleeve

14 connecting rod

15 bearing

16 axle

17 wheel

18 handle

21 U letter shaped frame

22 handle (hollow member)

23 receiving member

24 bar

25 support foot

30 bag

31 upper opening

32 rid member

33 belt

34 belt holder

35 connecting latch

40 LED (light emission diode) light

41 electric supply code

42 electric power source unit (battery box)

43 light cover (cloth)

45 pocket (for electric calculator)

46 Pocket (for folded umbrella)

47 pocket (for mobile telephone)

48 rectangular opening

49 rivet

50 support member

51,52 cut-off portion

53 pin

### PREFERABLE EMBODIMENT OF THE INVENTION

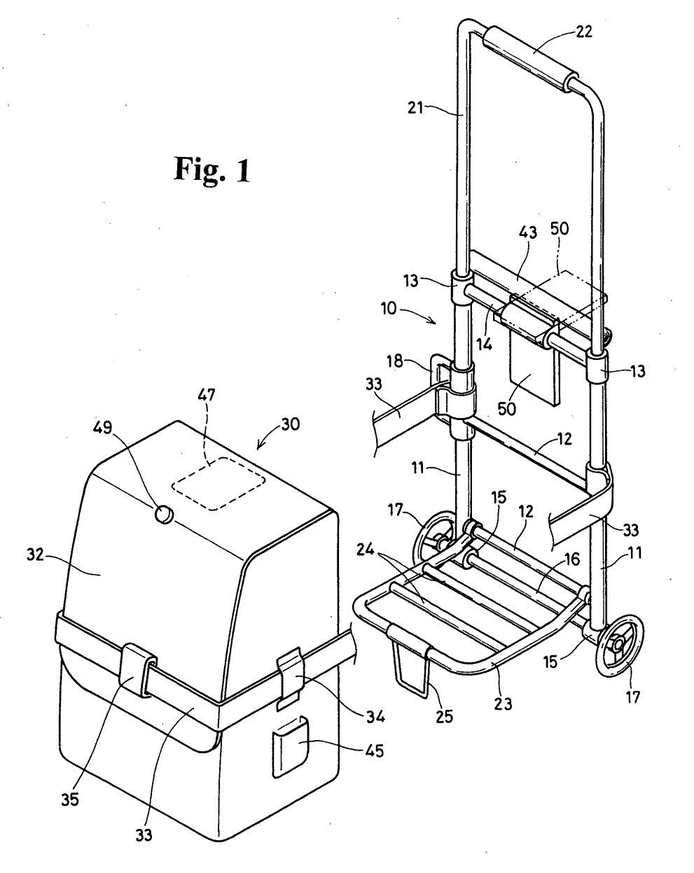

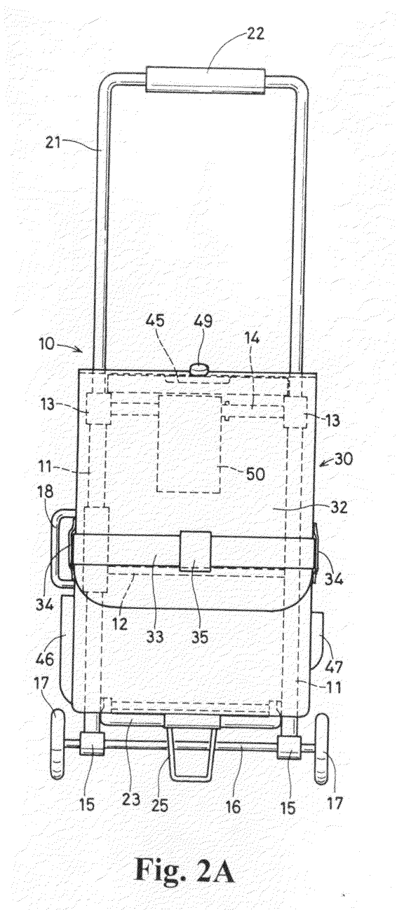

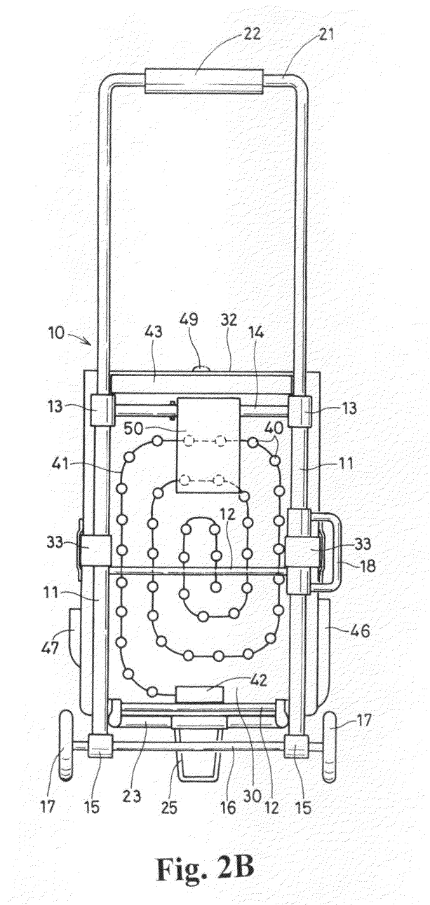

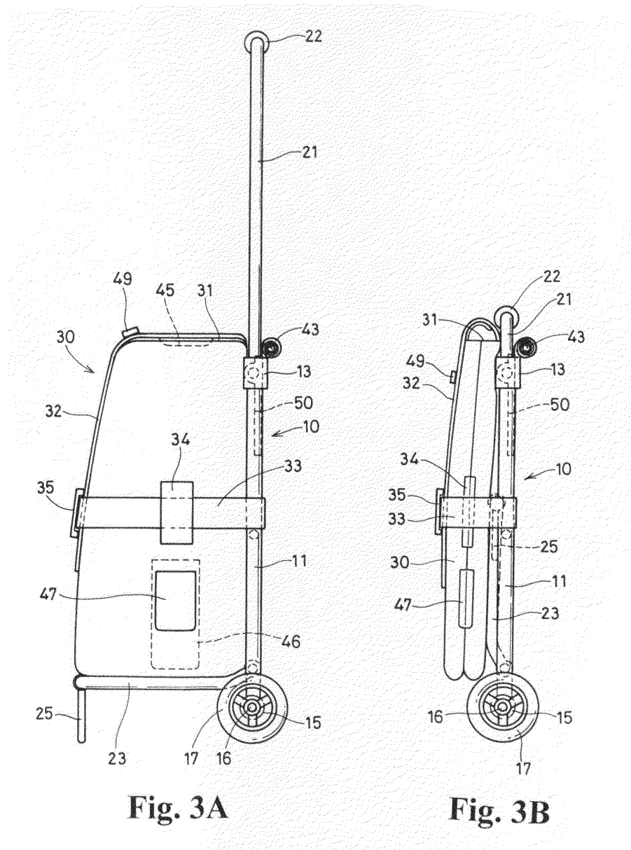

The prevent invention will now be described through an embodiment with accompanying drawings. FIG. 1˜FIG. 3 show a whole structure of a shopping car of this embodiment. As especially shown in FIG. 1 and FIG. 2, this shopping car has a frame 10, a shape of which is ladder. Namely, the frame 10 has a pair of left and right pipes 11 made of light-weight metal, and the left and right pipes 11 are connected by laterally arranged plural bars 12. Sleeves 13 made of synthetic resin are connected at the tops of left and right pipes 11, and left and right sleeves 13 are connected to each other by a connecting rod 14.

Bearing 15 are mounted at the bottom ends of the left and right pipes 11 which constitute a frame, and left and right bearings 15 and 16 rotatably support an axle 16. Wheels 17 are equipped on the both ends of the axle 16. Accordingly, the frame 10 is supported by the wheels 17.

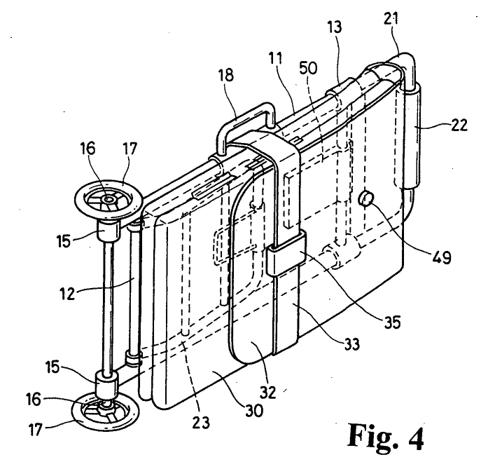

A U-letter shaped frame 21 is connected at the top of the frame 10. The outer diameter of the U-letter shaped frame 21 is substantially equal to or a little less than the inter diameter of the pipe 11 of the frame 10, and is receivable and drawerable from the frame 10 through the sleeves 13. A handle 22 made of hollow member is fitted on the top-side horizontal portion of the U-letter shaped frame 21. The frame 21 is drawn through the handle 22 for moving. Further another handle 18 is provided on the one side pipe 11 which enable to transport this shopping car in the folded state (FIG. 4).

A receiving member 23 is connected at the bottom side of the frame 10 and inside of a pair of bearings 15. The receiving member 23 is rotatable relative to the bottom end of a pair of left and right pipes 11 of the frame 10 (FIG. 3), and is receivable and drawerable. By this arrangement, the frame 10 with the receiving frame 23 is foldaway as shown in FIG. 3B and FIG. 4. The receiving member 23 has plural bars 24 at the intermediate positions. A support foot 25 is connected at the top of the receiving member 23, and the support foot 25 support the receiving member 23 horizontally.

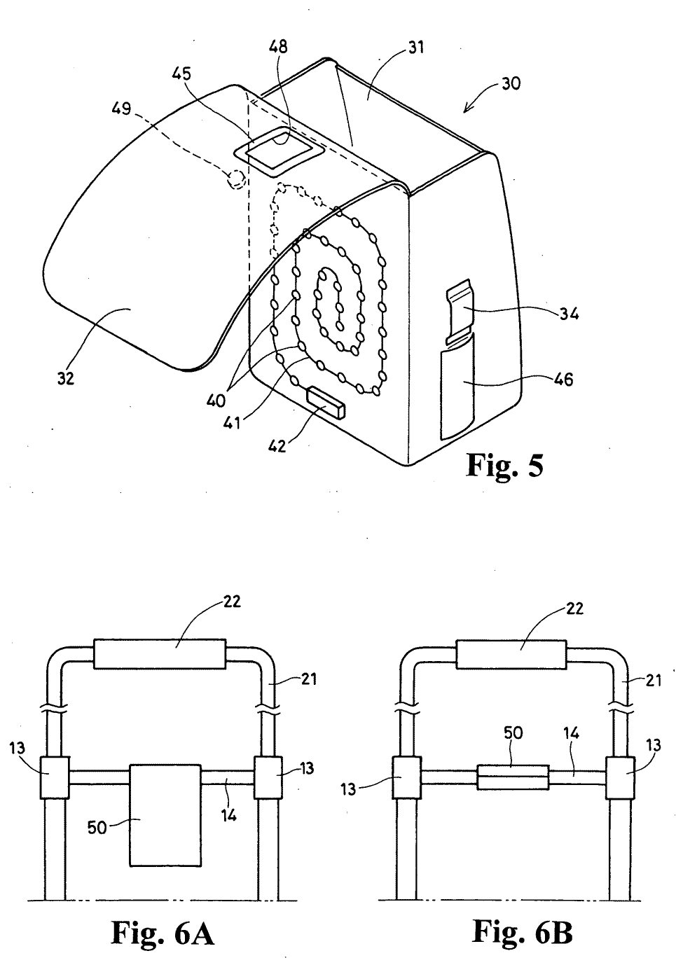

A bag 30 for receiving the goods is detouchably equipped on the receiving frame 23 of the frame 10. As shown in FIG. 1 and FIG. 5, the top opening 31 of the bag 30 is covered by a rid member 32 which is continuously extended from the behind portion of the bag 30, and the rid member 32 open and close the top opening 31. Further, the bag 30 is, as shown in FIG. 1 and FIG. 2, fixed to the pipe 11 of the frame 10 by means of a belts 33. The left and right ends of the belts 33 are fixed to the pipes 11 of the frame 10. The left and right belts 30 go through the belt holders 34 mounted on the both sides of the bag 30, and the top ends of the left and right belts 33 are connected to each other by a connecting latch 35 on the front surface of the bag 30.

A light means comprising LED (light emission diode) 40 are equipped on the behind side of the bag 30, as shown in FIG. 2B and FIG. 5. The LED lights 40 are connected to the electric supply code 41 in order, and the electric supply code 41 is spirally arranged and fixed on the behind surface of the bag 30. The end of the electric supply code 41 is connected to the electric power source unit 42 comprising a buttery box. When a switch (not shown) is turned, electric power is supplied from the electric power source unit 42 to the LED lights 40, and the LED lights 40 shine, and is performed an illumination. The LED lights 40 are covered by light cover 43 when necessary. The light cover 43 is, as shown in FIG. 3A and FIG. 3B, wound up and is fixed on the behind side of the frame 10 when not used. The wound light cover 43 may be fixed by fixing means for example, fastener.

A pocket 45 is formed inside of the rid member 32 of the bag 30 providing a light means comprising the LED lights 40 as shown in FIG. 5. The pocket 45 receives an electric calculator. The pocket 45 has a rectangular opening 48, through which the keys of the electric calculator is operated. Further a pocket 46 is provided on the left side lateral surface of the bag 30 for receiving a folded umbrella. On the contrary, a pocket 47 is provided on the right side lateral surface of the bag 30 for receiving a mobile telephone. These pockets 46, 47 respectively receive folded umbrella and mobile telephone.

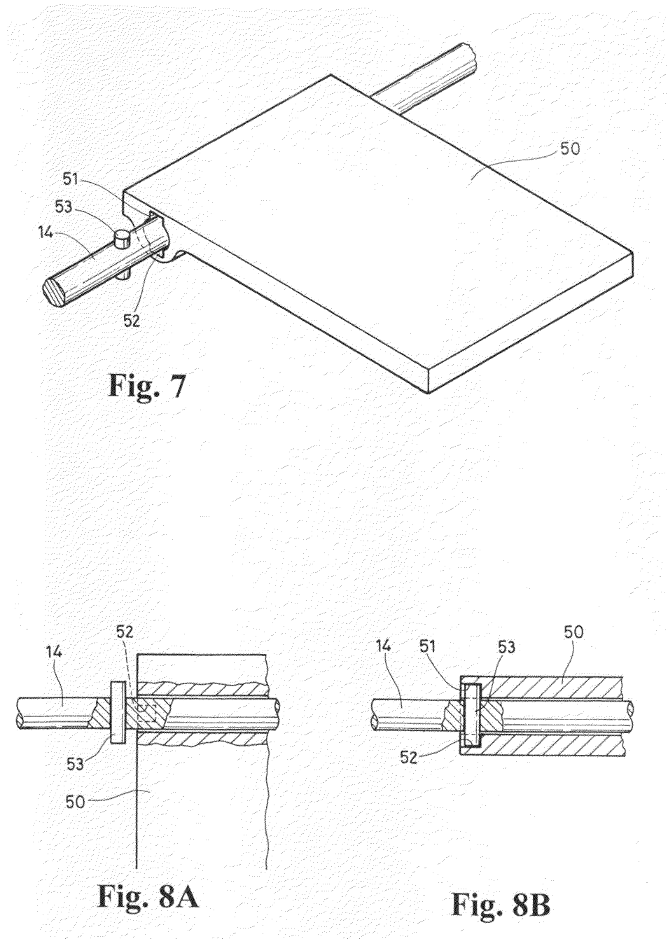

Next, an arrangement of the support member 50 will be described with reference to FIG. 6˜FIG. 8. The supporting member supports the electric calculator which is received in the pocket 45 formed on the rid member 32 of the bag 30. The connecting rod 14 which connects left and right sleeves 13 of the frame 10 rotatably support the support member 50. On the edge of a through hole of the support member 50, a pair of cut-off portions 51, 52 are formed. The cut-off portions 51, 52 engage with a pin 53 fixed on the connecting rod 14. By this arrangement, the support member 50 is horizontally maintained, as shown in FIG. 6B, FIG. 7 and FIG. 8B. A rivet 49 is fixed on the rid member 32 of the bag 30 and the rivet 49 project outwardly. When the support member 50 is drawn out and the rid member 32 is opened, the rivet 49 engages with the top edge of the support member 50. Accordingly, the electric calculator hold in the pocket 45 of the rid member 32 of the bag 30 is settled on the horizontally fixed support member 50 and the operationability of the electric calculator is improved.

Next, the usage of the above mentioned shopping car will be described. As shown in FIG. 3A, the receiving member 23 is opened by frontwardly rotating the member 23 when the bag 30 is to be furnished on the frame 10 of the shopping car. As shown in FIG. 3B, the receiving member 23 is foldaway, and the receiving member 23 receives and supports the bag 30 by horizontally open the receiving member 23 as shown in FIG. 3A. When the bag 30 is supported on the receiving member 23, the belts 33 connected to the left and right pipes 11 are drawn, and are then led through the belt holders 34 provided on the left side and right side of the bag 30. Then the top ends of the belts 33 are connected with each other through the connecting latch 35. Thus the bag 30 is supported on the receiving member 23 and is fixed to the frame 10, and is maintained in the fixed state.

On purchase, a pair of belts 33 are separated from each other by releasing the connecting latch 35, and the rid member 32 is opened as shown in FIG. 5. Purchased goods are received in the bag 30 trough the upper opening 31. Next, the rid member 32 again closes the upper opening 31 as shown in FIG. 1, and then the belts 33 are drawn frontwardly and connected to each other by the connecting latch 35. By the belts 33, the bag 30 is prevented from drop out from the frame 10, and the good are surely transferred.

As the shopping car of this arrangement directly receives the purchased goods therein on shopping in the super-market, the consumption of polymer bag can be reduced and indirectly contribute to protect the environment of the earth.

When the shopping car is not used and is under carrying or storage, the shopping car is folded as shown in FIG. 3B and FIG. 4. On folding operation, the both lateral sides and the bottom side are turned inside to form the bag 30 flat, and the receiving member 23 is rotated upwardly around the connecting hinge to fold the receiving member 23 on the pipe 11. The folded bag 30 is placed on the receiving member 23 and the bag 30 is fixed to the frame 10 by the belts 33. By this arrangement, the space for the shopping car is minimized on carrying or under storage.

As mentioned above, the bag 30 is folded and is fixed on the frame 10, and further the shopping car is carried in the folded condition. Namely, a handle 18 is equipped on the left side pipe 11. The shopping car can be carried through the handle 18 in the posture as shown in FIG. 4. As the folded shopping car is compact and light weight, one can carry the shopping car in the thrown posture as shown in FIG. 4 by grasping the handle 18.

Next, when purchaser draws the shopping car along the dark road on night, the LED light 40 provided on the surface of the behind-side of the bag 30 is lightened and the purchasers feet is shinned on. As shown in FIG. 2 and FIG. 5, the LED lights 40 are spirally arranged on the behind-side surface of the bag 30 through the electric supply code 41. When switch is turned on, the electric power is supplied from the electric power source unit 42 to the LED lights 40, and the LED lights 40 shine. Accordingly, the purchaser can shine on near the feet and draw the shopping car. Hence the stumbling of the drawer is prevented. Further, the driver of the motorcar and driver of the bicycle can recognize the walking purchaser drawing the shopping car through the LED lights 40 and hence the safeness can be improved.

The shopping car of this invention has the pocket 45 on the inside and upper side of the rid member 32, and the electric calculator is received in the pocket 45. When the electric calculator is to be used, as shown in FIG. 7 and FIG. 8B, the support member 50 is rotated around the connecting rod 14 to the horizontal angle, and then the support member is laterally moved toward left side as shown in FIG. 8B. By this movement, the cut-off portions 51 and 52 formed on the upper and lower edges of the through hole engage with the pin 53 of the connecting rod 14 for maintaining the support member 50 horizontally. Then the rid member 32 of the bag 30 is opened, and the rivet 49 is engaged on the top edge of the support member 50. The electric calculator received in the pocket 45 of the rid member 32 of the bag 30 is supported by the horizontally drawn support member 50. Accordingly the electric calculator is stably supported and the keys of the electric calculator is operated through the rectangular opening 48. Therefore, operationability of the electric calculator is improved.

As mentioned above, the keys of the electrical calculator received in the pocket 45 can be operative through to rectangular opening 48. But alternatively, the electric calculator is taken-out from the pocket 45, and the keys are directly operated by supporting the electric calculator on the support member 50 through the rid member 32. Further, the electric calculator may directly be supported on the support member 50 without intermediate substance of the rid member 32. A rid will preferably be provided on the pocket 45, and a fastener may preferably be equipped on the rid of the pocket 45 to prevent the electric calculator from falling out.

Still further this shopping car has a pocket 46 on one side of the bag for receiving a folded umbrella. Accordingly it is not necessary to receive the umbrella inside the bag 30, and the inner space of the bag 30 can effectively be utilized. Further, the operation to take-out the umbrella becomes easy.

On the opposite side of the bag 30, is formed a pocket 47, as shown in FIG. 2 and FIG. 3A, for receiving a mobile telephone 47. Accordingly another holding means, for example a hand bag, for the mobile telephone is not required. Further, leaving or loss of the mobile telephone will be prevented.

The present invention is now described with the accompanying embodiment, the present invention is not limited to above mentioned embodiment, and various modification should be allowed within the scope of the sprit of this invention. For example, various changes or modification can be allowed on the mechanism for supporting the electrical calculator horizontally and the foldaway mechanism for folding the receiving member 23 between a pair of pipes 11. Further, on the arrangements of the pocket 45 for receiving the electric calculator, the pocket 46 for receiving the folded umbrella and the pocket 47 for receiving the mobile telephone, various changes of designs can be allowed.

### POSSIBILITY OF INDUSTRIAL USAGE

The present invention can be used on the shopping car having a frame on which a bag is detachably equipped.

What is claimed:

1. A shopping car, comprising;
a frame having a handle on the upper side and a receiving member on the lower side,
wheels rotatably mounted on the lower side of said frame by means of bearings,
a bag furnished on said frame by supporting the bottom through said receiving member,
a support member provided on said frame receivablely and drawerably, and
a rid member furnished on the opening of said bag to open and shut said opening, the rid member having a pocket for receiving an electric calculator which is supported by said support member when said support member is drawn and said rid member opens said opening of said bag for the usage of said electric calculator.

2. A shopping car according to claim 1, wherein light means are provided on the behind-side of said bag.

3. A shopping car according to claim 2, wherein light means comprise plural light emission diodes (LED) connected to an electric supply code in order, and the electric supply code is furnished on the behind-side surface of said bag.

4. A shopping bag according to claim 1, wherein a pocket is furnished on one side of said bag for receiving a folded umbrella.

5. A shopping car according to claim 4, wherein another pocket is furnished on the another side of said bag for receiving a mobile telephone.

6. A shopping car according to claim 1, wherein said receiving member is foldaway relative to said frame, said handle is receivable and drawerable from said frame, and said frame is foldaway.
